(19) United States
(12) Patent Application Publication
(10) Pub. No.: US 2018/0285945 A1
(43) Pub. Date: Oct. 4, 2018

(54) Methods and Systems for Use in Providing Experience Profile Scores for Reviewers

(71) Applicant: MASTERCARD INTERNATIONAL INCORPORATED, Purchase, NY (US)

(72) Inventors: Ashutosh Kumar Gupta, Uttar Pradesh (IN); Ajay Nehra, Uttar Pradesh (IN); Nishant Maheshwari, Uttar Pradesh (IN)

(21) Appl. No.: 15/473,906

(22) Filed: Mar. 30, 2017

(51) Int. Cl. G06Q 30/02; G06Q 50/00

(52) U.S. Cl. CPC G06Q 30/0282; G06Q 50/01

(57) ABSTRACT

Systems and methods herein are suitable for use in providing experience profile scores for reviewers in connection with reviews submitted by the reviewers. One exemplary method includes receiving a request from a review forum for an experience profile score for a consumer. The request includes a subject of a review associated with the consumer and a device identifier associated with the consumer and/or associated with a communication device of the consumer. The method also includes compiling data associated with the device identifier where the data includes transaction data and at least one of social network content associated with the consumer and media content associated with the consumer, generating the experience profile score for the consumer in response to the request based on the compiled data, and distributing the experience profile score to the review forum for posting in connection with the review.

### FIELD

The present disclosure generally relates to methods and systems for use in providing experience profiles for reviewers in connection with reviews for products, services, etc., and in particular, to methods and systems for use in compiling the experience profiles for the reviewers where the experience profiles may be based on one or more of spend propensities of the reviewers, social network content associated with the reviewers, and/or other content qualifying the reviewers in connection with subject matter associated with their corresponding reviews.

### BACKGROUND

This section provides background information related to the present disclosure which is not necessarily prior art.

Consumers are known to purchase products (e.g., goods and services, etc.) from merchants. Transactions to purchase the products are commonly funded by payment accounts. Prior to, or after, the purchase of such products, consumers or others are known to provide reviews of the products and/or of the merchants at which the products were purchased. The reviews may include, for example, the consumers' descriptions and/or ratings of the products/merchants (e.g., based on a 1-5 star system, etc.). The reviews may also include comments about good and/or poor aspects of the products/merchants. Further, various merchants, and others (depending on to whom the reviews are submitted), publish the reviews to forums (e.g., to websites, etc.) to provide insight, as offered by the reviews, to potential consumers. In connection therewith, it is known for the reviews, and/or the ratings included in the reviews, to aid potential consumers in deciding whether to patronize the merchants and/or whether to purchase the products from the merchants, or not.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure operable to provide experience profiles for one or more reviewers submitting reviews, based on at least transaction data and/or social network data associated with the reviewers;

FIG. 2 is a block diagram of an exemplary computing device that may be used in the system of FIG. 1;

FIG. 3 is an exemplary method, which may be used with the system of FIG. 1, for providing experience profiles for one or more reviewers submitting reviews, based on at least transaction data and/or social network data associated with the reviewers; and

FIG. 4 is an exemplary interface including multiple reviews and associated experience profile scores, which may be used in connection with the system of FIG. 1 and/or the method of FIG. 3.

Corresponding reference numerals indicate corresponding parts throughout the several views of the drawings.

### DETAILED DESCRIPTION

Example embodiments will now be described more fully with reference to the accompanying drawings.

Consumers often purchase products (e.g., goods and services, etc.) through use of payment accounts. Separately, individuals, whether consumers or others, provide reviews of products and/or of merchants at which the products are purchased, whereupon the reviews may become available to potential consumers for the products and/or to the merchants, etc. The reviews often can alter the potential consumers' perception of the products to be purchased and/or the merchants from which the consumers may purchase the products, either positively or negatively. As such, it may be desirable to permit potential consumers to put the reviews into perspective based on the experience of the reviewers. Uniquely, the systems and methods herein permit reviews to be associated with experience profiles constructed based on the reviewers authoring the reviews. In particular, a profile engine compiles an experience profile for a reviewer providing a review, where the profile accounts for one or more aspects of a history of the reviewer, which either lends creditability to the reviewer, or not. Specifically, in accounting for such history of the reviewer, the profile engine relies on transaction data for the reviewer associated with the subject of the review, as well as, potentially, social network data for the reviewer and/or media data also associated with the subject of the review. In this manner, the review is able to be placed in perspective relative to other reviews (by other reviewers) for the same or similar subject matter, thereby permitting potential consumers to allow more experienced reviewers an enhanced ability to persuade or dissuade purchasing decisions. Accordingly, the potential consumers are presented with added information about the review not previously available when evaluating reviews and/or products for purchase.

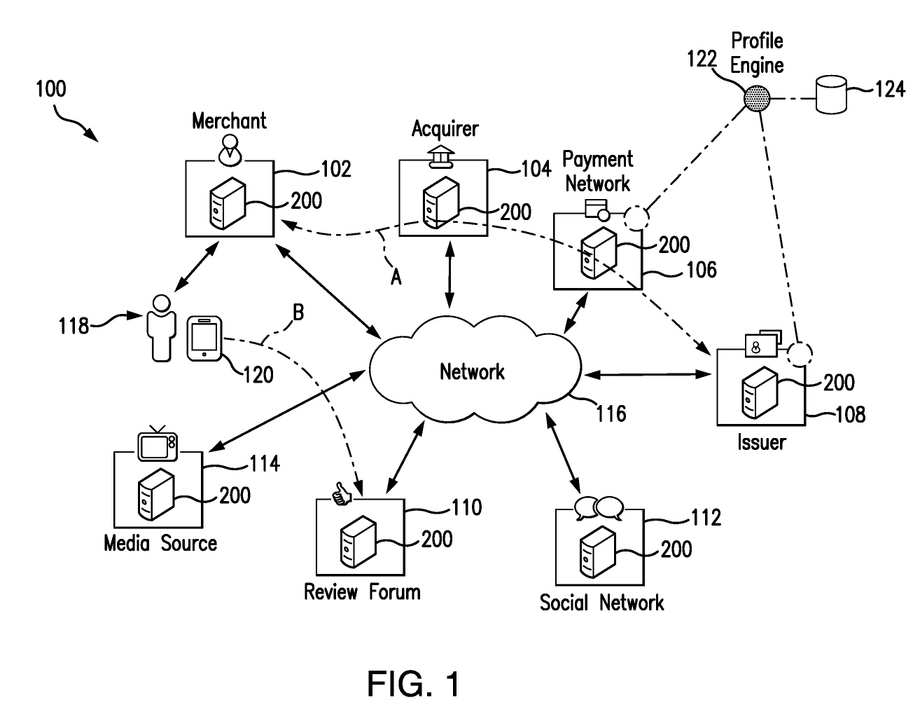

FIG. 1 illustrates an exemplary system 100, in which the one or more aspects of the present disclosure may be implemented. Although the system 100 is presented in one arrangement, other embodiments may include systems arranged otherwise depending, for example, on the manner in which reviews are published to potential consumers, when/how reviews are submitted and/or validated, etc.

The illustrated system 100 generally includes a merchant 102, an acquirer 104 associated with the merchant 102, a payment network 106, an issuer 108 configured to issue payment accounts to consumers, a review forum 110, a social network 112, and a media source 114, each of which is coupled to (and is in communication with) network 116. The network 116 may include, without limitation, a local area network (LAN), a wide area network (WAN) (e.g., the Internet, etc.), a mobile network, a virtual network, and/or another suitable public and/or private network capable of supporting communication among two or more of the parts illustrated in FIG. 1, or any combination thereof. For example, the network 116 may include multiple different networks, such as a private payment transaction network made accessible by the payment network 106 to the acquirer 104 and the issuer 108 and, separately, the public Internet, which is accessible as desired to the merchant 102, the acquirer 104, the issuer 108, the review forum 110, the social network 112, and the media source 114, etc.

In the exemplary embodiment, the merchant 102 is configured to offer for sale and to sell products to consumers including, for example, to consumer 118, shown in FIG. 1. The merchant 102 may be disposed and/or accessible at one or more physical locations, for example, at one or more brick-and-mortar locations, and/or at one or more virtual locations, for example, via one or more network-based applications (e.g., a website, etc.). Regardless of the location(s), though, consumers (e.g., the consumer 118, etc.) are able to interact with the merchant 102 to purchase products.

Also in the exemplary embodiment, the consumer 118 is associated with a payment account, which is issued to the consumer 118 by the issuer 108. In connection therewith, the consumer 118 is then able to use the payment account to fund transactions for the purchase of products with merchants, including with the merchant 102.

In one example transaction, when the consumer 118 identifies a product to purchase at the merchant 102, for example, the consumer 118 presents a payment device associated with the consumer's payment account to the merchant 102 to initiate the transaction for the product. The merchant 102 receives and/or retrieves credentials for the consumer's payment account from the payment device, for example, via a point-of-sale (POS) terminal, and then communicates an authorization request for the transaction to the acquirer 104 through the network 116 (along path A in FIG. 1, as is conventional). In turn, the acquirer 104 communicates the authorization request with the issuer 108, through the payment network 106 (again via the network 116), for authorization of the transaction (e.g., to determine if the user's payment account is in good standing and if there is/are sufficient credit/funds to complete the transaction, etc.). If the issuer 108 accepts the transaction, an authorization reply is provided back to the merchant 102 (again, generally along path A) approving the transaction, and the merchant 102 is then able to proceed with the transaction. The transaction is later cleared and settled by and between the merchant 102 and the acquirer 104 and by and between the acquirer 104, the payment network 106, and the issuer 108 (in accordance with appropriate settlement arrangements, etc.). Conversely, if the issuer 108 declines the transaction, an authorization reply is provided back to the merchant 102 declining the transaction, and the merchant 102 is able to terminate the transaction with the consumer 118, or request an alternate form of funding.

Transaction data is generated, collected, and stored as part of the above interactions among the merchant 102, the acquirer 104, the payment network 106, the issuer 108, etc. The transaction data, in this exemplary embodiment, is stored at least by the payment network 106 (e.g., in a data structure associated with the payment network 106 (or in association with a profile engine 122, as described below), etc.). With that said, transaction data may include, for example, payment account numbers (e.g., primary account numbers (PANs), etc.), transaction amounts, merchant IDs, merchant category codes (MCCs), region codes for merchants involved in transactions, merchant names, dates/times, products purchased and related descriptions or identifiers thereof, etc. It should be appreciated that more or less information related to transactions, as part of either authentication of consumers, authorization and/or clearing and/or settling of the transactions, etc., may be included in transaction data and stored within the system 100, at the merchant 102, the acquirer 104, the payment network 106, and/or the issuer 108. Further, data unrelated to particular payment accounts may be collected by a variety of techniques, and similarly stored within the system 100.

In this exemplary embodiment, the review forum 110 is configured to solicit and to accept reviews for products and/or merchants (e.g., for the merchant 102, etc.), from consumers or other persons, and further to publish the reviews for the consumers (e.g., on behalf of the consumers, etc.), thereby enabling other consumers (e.g., potential consumers for the given products and/or the merchant 102, etc.) to view the reviews. The review forum 110 may include, without limitation, one or more social network-based applications or other forums suitable to be used as described herein, such as, for example, Yelp™, Reddit™, Zomato®, Angie's List™, TripAdvisor™, or the like, etc. In this exemplary embodiment, the consumer 118 is a participant in the review forum 110, with one or more reviews posted thereto related to one or more topics and/or subjects, as described in more detail below. It should be appreciated that the review forum 110 may be associated with the merchant 102 (forming part of the merchant's website, for example), or it may be substantially independent from the merchant 102, as a separate entity or otherwise.

Also in this exemplary embodiment, the social network 112 may include, generally, any forum in which the consumer 118, and potentially other consumers, is/are permitted to contribute content for review by himself/herself, or by others. Example social networks 112 included, for example, Facebook®, Twitter®, Google+®, Flickr®, Instagram®, LinkedIn®, Myspace®, Pinterest®, etc. The social network 112 is configured to provide access for requesting, retrieving, and/or viewing social network content specific to one or more consumers, for example, via an application programming interface (API), which is accessible as provided herein, etc. Like the review forum 110, the consumer 118 maintains a profile and/or presence at the social network 112, whereby content (e.g., posts, pins, likes, tags, etc.) provided by the consumer 118 are posted and/or available to other participants in the social network 112.

And, the media source 114 may include, without limitation, any source of media content, which may be ordered, viewed, recorded, etc. (broadly, consumed), by the consumer 118. Example media sources include, for example, DIRECTV®, AT&T U-verse®, Hulu®, Amazon®, Netflix®, Chromecast®, etc. The media source 114 may be accessible, to the consumer 118, via one or more Internet-Of-Things (IoT) devices, or other devices, associated with the consumer 118 (e.g., within the premises or residence of the consumer 118, etc.). The media source 114 is configured to provide access for requesting, retrieving, and/or viewing media content (e.g., titles, actors, view times, descriptions, frequency, schedule, etc. (collectively, or per device), but generally not the entire movie, show, article, etc.) specific to one or more consumers, for example, via an application programming interface (API), which is accessible as provided herein, etc. Again, the consumer 118 is a member, subscriber, and/or otherwise associated with the media source 114, such that the consumer 118 selects, views, and/or reads content from the media source 114.

In various exemplary embodiments, consumers (e.g., the consumer 118, etc.) involved in the different transactions/interactions herein (whether via the payment network 106 or through the review forum 110, the social network 112, and/or the media source 114) are prompted to agree to legal terms associated with the respective accounts (e.g., payment accounts, social network account, etc.), for example, during enrollment, upon installation of related applications, etc. In so doing, the consumers may voluntarily agree, for example, to allow certain entities to collect data associated with the accounts and to use data collected during enrollment and/or collected in connection with use of the accounts, subsequently, at least for one or more of the different purposes described herein.

With continued reference to FIG. 1, the consumer 118 in the system 100 is associated with a communication device 120. The communication device 120 may include, for example, a smartphone, a laptop, a tablet, etc. Often, though, the communication device 120 will include a portable communication device, so that the communication device 120 is located with and/or is carried with the consumer 118, for use as described herein. The communication device 120 is associated with a unique identifier, which may include, for example, a device ID, a media access control (MAC) address, a mobile equipment identifier (MEID), a serial number, or even an identifier associated with a network-based application therein (e.g., an application ID, etc.), which may be used to identify the communication device 120 (as compared to one or more other communication devices). In addition, the communication device 120 is associated with (or includes) a payment application (e.g., a virtual wallet application, etc.) to which the consumer's payment account is associated. As such, the consumer 118 is able to use the communication device 120 to perform purchase transactions at various merchants (including the merchant 102) as described herein (and using the consumer's payment account issued to the consumer 118 by the issuer 108).

While only one consumer 118 is shown in the system 100 in FIG. 1, it should be appreciated that more than one consumer (and, often, tens, hundreds, thousands, etc. of consumers) may be included in the system 100 and/or in other system embodiments. Similarly, while only one merchant 102, one acquirer 104, one payment network 106, one issuer 108, one review forum 110, one social network 112, and one media source 114 are illustrated, it should be appreciated that any number of these entities (and their associated components) may be included in the system 100, or may be included as a part of systems in other embodiments, consistent with the present disclosure.

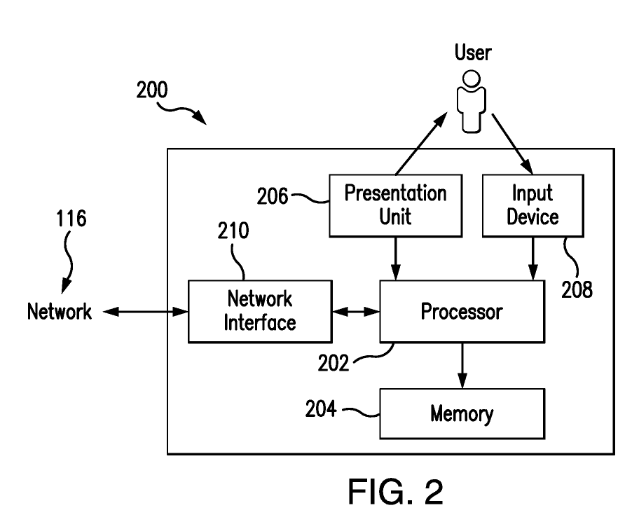

FIG. 2 illustrates an exemplary computing device 200 that can be used in the system 100. The computing device 200 may include, for example, one or more servers, workstations, personal computers, laptops, tablets, smartphones, terminals, etc. In addition, the computing device 200 may include a single computing device, or it may include multiple computing devices located in close proximity or distributed over a geographic region, so long as the computing devices are specifically configured to function as described herein. In the system 100 of FIG. 1, each of the merchant 102, the acquirer 104, the payment network 106, the issuer 108, the review forum 110, the social network 112, and the media source 114 are illustrated as including, or being implemented in, a computing device 200 coupled to (and in communication with) the network 116 (to provide communication therebetween). In addition, the communication device 120 associated with the consumer 118 is also consistent with the computing device 200, and may be coupled to (and in communication with) the network 116. That said, however, the system 100, or parts thereof, should not be understood to be limited to the computing device 200, as other computing devices may be employed in other system embodiments. In addition, different components and/or arrangements of components may be used in other computing devices.

Referring to FIG. 2, the exemplary computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, transaction requests, product reviews, merchant reviews, spend profiles (e.g., ratings, scores, etc.), social network content, media source content, and/or other types of data (and/or data structures) as needed and/or suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. Such instructions often improve the efficiencies and/or performance of the processor 202 that is performing one or more of the various operations herein.

It should be appreciated that the memory 204 may include a variety of different memories, each implemented in one or more of the operations or processes described herein.

In the exemplary embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., reviews, spend profiles, tags or indicators, etc.), either visually or audibly, to a user of the computing device 200, for example, the consumer 118 in the system 100 (e.g., at the communication device 120, etc.), a user associated with the merchant 102, a user associated with the review forum 110, etc. Various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, presentation unit 206 includes multiple devices.

The computing device 200 also includes an input device 208 that receives inputs from the user (i.e., user inputs) such as, for example, entries of reviews, requests for validation and/or spend profiles, etc., or inputs from other computing devices. The input device 208 is coupled to (and is in communication with) the processor 202 and may include, for example, a keyboard, a pointing device, a mouse, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network 116. Further, in some exemplary embodiments, the computing device 200 includes the processor 202 and one or more network interfaces incorporated into or with the processor 202.

Referring again to FIG. 1, the system 100 includes the profile engine 122, which is configured, by executable instructions, to operate as described herein. The profile engine 122 is shown in FIG. 1 as a standalone part of the system 100, and is generally consistent with computing device 200. Alternatively, and as indicated by the dotted lines in FIG. 1, the profile engine 122 may be incorporated, in whole or in part, into the issuer 108 and/or the payment network 106 (or potentially, in some embodiments, the review forum 110 or the other entities of the system 100; etc.). In addition, the profile engine 122 is coupled to a data structure 124, which may be standalone from the profile engine 122 or, as indicated by the dotted line, may be incorporated in whole, or in part, with the profile engine 122. The data structure 124 includes, at the least, transaction data for the payment account associated with the consumer 118 (e.g., as received from and/or provided by the payment network 106 and/or the issuer 108, etc.) and, potentially, transaction data for payment accounts associated with other consumers. The data structure 124 further includes content from the social network 112 and/or media source 114, as described in more detail below.

In this exemplary embodiment, the profile engine 122 is configured to compile an experience profile for the consumer 118, in connection with one or more reviews at the review forum 110.

In particular, as part of the submission of a review to the review forum 110 by the consumer 118 (along path B in FIG. 1), for example, the profile engine 122 is configured to identify the consumer 118 submitting the review, for example, based on a device identifier associated with the consumer's communication device 120 (e.g., a device ID, an email address, a phone number, etc.) through which the review is being submitted/provided to the review forum 110. In one or more other embodiments, upon identifying the consumer 118 (and/or the communication device 120), the profile engine 122 may be configured to solicit verification of the consumer 118 to one or more accounts associated with the consumer 118, for example, via a login, etc. The profile engine 122 is further configured to compile data related to the consumer 118, associated with the one or more accounts, through one or more sources. In this embodiment, the profile engine 122 is configured to retrieve content related to the consumer 118 from the data structure 124, or from one or more of the payment network 106, the social network 112 and/or the media source 114, and store the content in the data structure 124.

The profile engine 122 is configured to retrieve transaction data from the data structure 124 and/or from the payment network 106 (and/or from the issuer 108), based on the identification of the consumer 118. In particular, in at least one embodiment, the profile engine 122 is configured to retrieve transaction data for the consumer 118 for all transactions, or for particular transactions, etc. (as desired), and/or performed through the consumer's communication device 120 (e.g., via the virtual wallet application at the consumer's communication device 120, etc.). In so doing, the profile engine 122 is configured to use the device identifier for the communication device 120 to identify the consumer 118 and/or the communication device 120 and/or the payment account associated with the consumer 118 and retrieve (e.g., via an API associated with the payment network 106, etc.) the transaction data associated therewith. Additionally, or alternatively, the profile engine 122 is configured to retrieve limited data from the payment account, for example, based on an interval of time (e.g., last 30 days, etc.), a category, etc. For example, when a review relates to a restaurant (e.g., merchant 102 in this example, etc.), the profile engine 122 may be configured to retrieve transaction data from the data structure 124 and/or from the payment network 106 for the consumer 118 related to the restaurant, for example, by retrieving all of the consumer's transactions including an MCC associated with restaurants (e.g., MCC 5812 for Eating places and Restaurants) within a defined interval (e.g., a last 30 days, a last six months, a last year, a longer interval, a shorter interval, etc.).

In addition, the profile engine 122 is also configured to retrieve data from the social network 112 (i.e., social network content) for the consumer 118, based on the device identifier for the communication device 120. When the consumer 118 accesses the social network 112 and/or otherwise makes use of the social network 112 through the communication device 120, the identifier associated with the communication device 120 is linked to the account for the consumer 118 at the social network 112. In general, this link will continue and/or exist even when the account at the social network 112 is previously, or later, accessed/used, by the consumer 118, through another connected device such as a laptop, etc. As such, the consumer 118 can be identified in connection with the social network 112 based on the device identifier for the consumer's communication device 120. The profile engine 122 is configured to then access the consumer's account at the social network 112 (e.g., via an API associated with the social network 112, etc.) (based on the device identifier) and/or to search within the content of the profile associated with the account for content that is specific to the subject of the review (or all content in some embodiments). As an example, where the subject of the review is a restaurant, the profile engine 122 is configured to search for social network content related to restaurants, including, for example, posts associated with the consumer 118 about restaurants, chefs, cooking shows, cooking techniques, recipes, etc. (to a social network account as identified based on the device identifier for the consumer's communication device 120). Upon identification of specific content, the profile engine 122 is configured to pull the content to the data structure 124 (and store it therein). In general, the profile engine 122 is configured to access the social network content at the social network 112 and compile content therefrom, but without pulling the full and/or actual content (e.g., the text of the posts, etc.) from the social network 112. For example, the profile engine 122 may be configured to simply determine a number of posts associated with the consumer 118 related to a restaurant (e.g., based on all available posts, based on posts over a defined interval, etc.).

And, the profile engine 122 is also configured to retrieve data from the media source 114 (i.e., media source content) for the consumer 118, based on the device identifier for the communication device 120. Similar to above, when the consumer 118 accesses the media source 114 and/or otherwise makes use of the media source 114 through the communication device 120, such that the account and/or subscription associated with the access/use is linked to the communication device 120 (via the device identifier of the communication device 120). In general, this link will continue and/or exist even when the media content (through the account and/or subscription) is accessed/used through another connected device (e.g., an Internet of Things (IoT) device, etc.), at a prior or later time, etc. As such, again, the media source content in connection with the media source 114 can be identified to the consumer 118 based on the device identifier for the consumer's communication device 120. Like above, the profile engine 122 may be configured to access the consumer's account at the media source 114 (e.g., via an API associated with the media source 114, etc.), based on the device identifier for the communication device 120, and search therein for content that is specific to the subject of the review (or all content in some embodiments). In the above example, where the subject of the review is a restaurant, the profile engine 122 is configured to retrieve (e.g., receive, pull, request, etc.) media source content including, for example, shows related to restaurants or cooking (e.g. frequency of views by the consumer 118, number of views by the consumer 118, etc.), recordings related to cooking, etc. Upon identification of specific content, the profile engine 122 is configured to pull the content (e.g., titles, actors, view times, descriptions, frequency, schedule, counts, etc., but generally not the entire movie, show, etc.) to the data structure 124 (and store it therein). In general, the profile engine 122 is configured to access the media source content and to retrieve content (e.g., details, etc.) of the consumer's use, but without pulling the full and/or actual content (e.g., the movie, the article, the show, etc.) from the media source 114.

With that said, Table 1 includes an example segment of data that may be included in the data structure 124. The example segment includes a segment of transaction data, social network data, and media source data retrieved for the consumer 118. It should be appreciated that additional data, different data, etc. may be included in the data structure 124 in other embodiments.

TABLE 1

| | | Representa- |
|---|---|---|
| Factor | | tive Value |
| 1 | Has the consumer 118 performed transaction at the | Yes |
| | merchant 102 in the past three months | |
| 2 | Total number of transactions by consumer 118 at the | 30 |
| | merchant 102 in past three months | |
| 3 | Total number of transactions by the consumer 118 at | 35 |
| | Restaurants in past three months | |
| 4 | Total amount of transactions by consumer 118 made in | $172.24 |
| | Restaurants in past month | |
| 5 | Number of food related pages liked/subscribed to by | 50 |
| | consumer 118 on Facebook ® | |
| 6 | Number of times keywords like “food” are used by | 70 |
| | consumer 118 in status on Facebook ® or in tweets on | |
| | Twitter ® in past three months | |
| 7 | Number of chefs/food connoisseurs followed by | 80 |
| | consumer 118 on twitter and friended/followed on | |
| | Facebook ® | |
| 8 | Number of groups related to food joined by consumer | 55 |
| | 118 on Facebook ® | |
| 9 | Number of food related searches performed by | 60 |
| | consumer 118 on Google ® in past three months | |
| 10 | Number of food related videos viewed by consumer | 80 |
| | 118 on YouTube ® in past three months | |
| 11 | Number of food blogs visited by consumer 118 in the | 90 |
| | past three months | |
| 12 | Number of restaurants checked on the Internet by | 132 |
| | consumer 118 in past three months | |
| 13 | Number of times a cookery show has been viewed by | 0 |
| | consumer 118 on TV in the past three months | |

Further in the system 100, upon compiling/retrieving the various data related to the consumer 118 (from/to the data structure 124, from the payment network 106, from the social network 112, from the media source 114, etc.), the profile engine 122 is configured to compile an experience profile for the consumer 118 based on the data. In one example, in connection with compiling the experience profile, the profile engine 122 is configured to generate a score indicative of the consumer's experience on the subject of the given review (i.e., the review submitted to the review forum 110). Specifically in this example, the profile engine 122 is configured to employ the following algorithm to compile the experience profile score for the consumer based on one to z factors associated with the experience of the consumer 118 (in connection with the subject matter of the consumer's review), where X is a particular experience factor for the consumer 118 and W is a weighting factor associated with the given experience factor:

Experience Profile Score=(X₁*W₁)+(X₂*W₂)+(X₃*W₃)+ . . . (X_{Z}*W_{Z})

With reference to the above “restaurant” review example, various exemplary experience factors for the consumer 118 (for use in the above algorithm) may include a number of transactions by the consumer 118 at the subject restaurant in the last month, a total number of transactions by the consumer 118 in the last three months, a total number of transactions at the restaurant in the last three months, a number of food related pages that the consumer 118 has “liked” at the social network 112, a number of chefs or food connoisseurs the consumer 118 follows on the social network 112, a number of food related videos the consumer 118 has seen in the last three months via the media source 114, etc.

Further, for the above algorithm, the experience factors may be provided to and/or utilized based on the particular values of the factors. Or, the experience factors may be provided to and/or utilized based on a common scale, which may, in turn, be based on various ranges (e.g., a common scale of 0-5, a common scale of 0-100, etc.). For example, when the factors are on a scale of 0-5, the number of transactions to merchants in the same category (i.e., restaurants) over the last three months may be provided as follows: a factor of “0” for 0-2 transactions, a factor of “1” for 3-6 transactions, a factor of “2” for 7-10 transactions, a factor of “3” for 11-20 transactions, a factor of “4” for 21-30 transactions, and a factor of “5” for more than 30 transactions. And, for the same scale of 0-5, the amount of transactions to merchants in the same category (i.e., restaurants) over the last three months may be provided as follows: a factor of “0” for $0-$25, a factor of “1” for $26-$50, a factor of “2” for $51-$75, a factor of “3” for $76-$100, a factor of “4” for $101-$125, and a factor of “5” for more than $125.

A similar approach may be used to scale the data associated with the social network 112 and the media source 114. It should be appreciated that the ranges listed herein are merely provided for purposes of illustration and that other ranges and/or other manners of providing the factors for the above algorithm, or others, may be employed.

Then in the system 100, after generating the experience profile score for the consumer 118, the profile engine 122 is configured to post, or cause to have posted (e.g., at the review forum 110, etc.), the experience profile score in association with the review by the consumer 118. Thereafter, in the associated review forum 110, potential consumers are able to read the review submitted by the consumer 118, evaluate the review based on the experience profile score for the consumer 118, and, potentially, rank the review (in association with other reviews) by the experience profile score, etc.

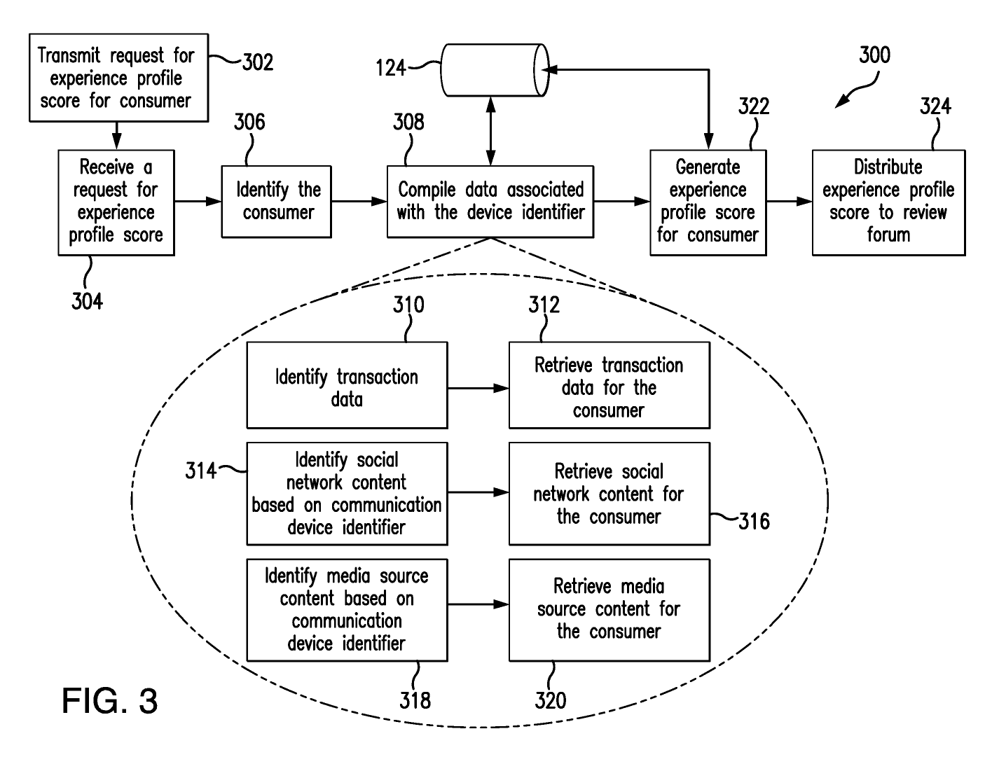

FIG. 3 illustrates an exemplary method 300, for use in providing experience profiles for reviewers, in connection with reviews provided by the reviewers for merchants and/or products. The exemplary method 300 is described as implemented in the profile engine 122 of the system 100, and with further reference to the data structure 124, the consumer 118, and the communication device 120, etc. of the system 100, and also with reference to the computing device 200. The methods herein, however, should not be understood to be limited to the system 100 and/or the computing device 200. Likewise, the systems and devices herein should not be understood to be limited to the method 300.

In connection with the method 300, the consumer 118 submits, or is in the process of submitting, a review to the review forum 110 for a restaurant, i.e., the merchant 102, which is the subject of the review (e.g., along path B in FIG. 1, etc.). It should be appreciated that the specific merchant, being a restaurant, is included for purposes of illustration only and that the method 300 may be employed in connection with various different types of reviews, for various different types of merchants, products, etc.

In response to the review, or a request by the consumer 118 to submit the review, the review forum 110 transmits a request, at 302, for an experience profile score for the consumer 118 to the profile engine 122. In this exemplary embodiment, the request includes, for example, a name associated with the consumer 118 and, generally, without the consumer 118 specifying, a device identifier associated with the communication device 120 (e.g., where the consumer 118 is facilitating the review through the communication device 120, where the account(s) referred to herein were accessed by the communication device 120, etc.). As described in connection with the system 100, the device identifier may include, without limitation, a static ID specific to the communication device 120, through which the review or request to submit a review is provided by the consumer 118, including, for example, a MAC address, a MEID, an electronic serial number (ESN), etc. Additionally, or alternatively, the device identifier may include a phone number, email address or other contact information specific to the consumer 118 and known and/or associated with the communication device 120. Further, the device identifier may include a token (e.g., a payment token, etc.) or other credential/certificate provisioned to the communication device 120, for one or more purposes, etc., for example, for use by the profile engine 122 to identify transaction data for the consumer 118, etc.

In turn, the profile engine 122 receives, at 304, the request for the experience profile score, and identifies, at 306, the consumer 118 (or communication device 120) based on the device identifier. Thereafter, the profile engine 122 compiles data associated with the device identifier, at 308, where the data is indicative of and/or related to the consumer's experience and/or expertise with regard to the subject matter of the corresponding review. In this example, the subject of the review is the merchant 102, which is a restaurant. As such, the subject matter of the review generally relates to restaurants, food, etc. And, the compilation of data relating thereto includes, in this example (and without limitation), compilation of data related to transactions by the consumer 118 (e.g., transaction data from the payment network 106, etc.), to social network data associated with the consumer 118 from the social network 112, and/or to media data for the consumer 118 from the media source 114.

As described above in the system 100, such data may be retrieved from the data structure 124, from the payment network 106, from the social network 112, and/or from the media source 114. What's more, data retrieved from the payment network 106, from the social network 112, and/or from the media source 114 may then be stored in the data structure 124 for subsequent use, as desired.

Initially when compiling the data in the illustrated method 300, (and not indicative of a specific order or temporal requirement), the profile engine 122, based on the device identifier, identifies, at 310, a payment account associated with the consumer 118 and corresponding transaction data. For example, where the device identifier includes a token associated with the consumer's payment account (and in particular with the consumer's payment account as tokenized through the virtual wallet application at the consumer's communication device 120), the profile engine 122 submits the token (e.g., via an API associated with the payment network 106, etc.), with a request for transaction data for the consumer 118, to the payment network 106. One exemplary request may include the token and a request for transaction data for all transactions by the consumer 118 with the MCC 5812 (i.e., Eating places and Restaurants) and also (or alternatively) for all transactions by the consumer 118 at merchant 102, in the last one month, three months or some other defined interval. In response, the payment network 106 compiles the requested transaction data and the profile engine 122 retrieves, at 312, the compiled transaction data from the payment network 106. It should be understood that retrieving the transaction data from the payment network 106 may include detailed transaction data (e.g., details per transaction, etc.), or may include summary transaction data for the consumer's payment account and corresponding transactions (e.g., number of transactions to the merchant 102, total spend in MCC 5812, etc.). Table 1 above, again, illustrates a segment of transaction data for the consumer 118 that may be retrieved by the profile engine 122 related to a review for the merchant 102 and stored in the data structure 124 (e.g., at 308 in the method 300, etc.).

In addition, at 314, the profile engine 122 identifies the social network content associated with the consumer 118, based on the device identifier. Specifically, in this example, the profile engine 122 identifies the social network content and/or account associated with the consumer 118 through the device identifier for the consumer's communication device 120 and then accesses and/or retrieves the social network content (e.g., via an API associated with the social network 112, etc.). In response, the social network 112 provides, makes available, and/or compiles the requested data relating to the consumer 118. The profile engine 122 then retrieves, at 316, the social network content from the social network 112. It should be understood that retrieving the social network content from the social network 112 may include specific social network content (e.g., posts, “likes”, etc.) associated with the consumer 118, or it may include a summary of the social network content for the social network profile associated with the consumer 118 (e.g., number of food-related pages the consumer 118 has liked on Facebook® social network, number of chefs followed by the consumer 118 on Twitter® social network, etc.). Again, Table 1 above illustrates a segment of social network content for the consumer 118 that may be retrieved by the profile engine 122 related to a review for the merchant 102 and stored in the data structure 124 (e.g., at 308 in the method 300, etc.).

And, at 318, the profile engine 122 identifies the media content associated with the consumer 118, based on the device identifier. Specifically, in this example, the profile engine 122 identifies the media content associated with the consumer 118 through the device identifier for the consumer's communication device 120 and then accesses the media content (e.g., via an API associated with the media source 114, etc.). In response, the media source 114 provides, makes available, and/or compiles the requested data relating to the consumer 118 and the profile engine 122 retrieves, at 320, the media content from the media source 114. It should be understood that retrieving the media source content from the media source 114 may include the specific media content associated with the consumer 118 (e.g., movies, shows, etc. viewed by the consumer 118, saved by the consumer 118, rented by the consumer 118, purchased by the consumer, etc.; etc.), or it may include a summary of the media content for the media account associated with the consumer 118 (e.g., titles for, descriptions of, number of, etc. food shows viewed by the consumer 118 in the last month (or three months), etc.; etc.). Consistent with the above, Table 1, again, illustrates a segment of media content for the consumer 118 that may be retrieved by the profile engine 122 related to a review for the merchant 102 and stored in the data structure 124 (e.g., at 308 in the method 300, etc.).

It should be appreciated that while transaction data, social network content, and media content are each retrieved by the profile engine 122 in the exemplary method 300 (for use in generating the experienced profile for the consumer 118), more, less, or different data/content may be compiled and/or retrieved (and used, as described below) in other method embodiments (for use in generating the experience profile for the consumer 118). For example, the profile engine 122 may rely on the transaction data and the social network content, but not the media content, in other embodiments; or the profile engine 122 may rely on the transaction data and media content, but not the social network content, in still other embodiments.

In addition to the above, the compiling of data, by the profile engine 122, may involve a variety of different intervals for which transaction data, social network content, and/or media content is retrieved. In one example, transaction data, social network content, and/or media content for the last 45 days is retrieved. In another example, transaction data for the last 60 days (e.g., a first interval, etc.) is retrieved, while social network content for the last 30 days (e.g., a second interval, etc.) is retrieved. In the latter example, while the intervals are different, they overlap. It should be appreciated, however, other intervals, which overlap or not, may be defined for retrieval of transaction data, social network content, and/or media content.

With continued reference to FIG. 3, next in the method 300, the profile engine 122 generates the experience profile score for the consumer 118, at 322. In this embodiment, the profile engine 122 relies on the algorithm described above to generate the experience profile score, and the list of factors and weightings summarized in Table 2.

TABLE 2

| | Score | |
|---|---|---|
| Factor | Ranges | Weight |
| Has the consumer 118 had transaction at the | 0 (No) or | 0.65 |
| merchant 102 in the past three months? | 100 (Yes) | |
| Total number of transactions made by the | 0-100 | 0.05 |
| consumer 118 at the merchant 102 in past three | | |
| months | | |
| Total number of transactions made by the | 0-100 | 0.03 |
| consumer 118 in Restaurants in past three | | |
| months | | |
| Total amount of transactions made by the | 0-100 | 0.01 |
| consumer 118 in Restaurants in past month | | |
| Number of food related pages that the consumer | 0-100 | 0.03 |
| 118 has liked/subscribed on Facebook ® | | |
| Number of times consumer 118 has used | 0-100 | 0.01 |
| keywords like “food” in their status on | | |
| Facebook ® or in their tweets on Twitter ® in | | |
| past three months | | |
| Number of chefs/food connoisseurs that | 0-100 | 0.04 |
| consumer 118 follows on twitter and is | | |
| friend/follows them on Facebook ® | | |
| Number of groups related to food that consumer | 0-100 | 0.04 |
| 118 has joined on Facebook ® | | |
| Number of food related searches that consumer | 0-100 | 0.02 |
| 118 has made on Google ® in past three months | | |
| Number of food related videos consumer 118 | 0-100 | 0.03 |
| has seen on YouTube ® in past three months | | |
| Number of food blogs visited by consumer 118 | 0-100 | 0.04 |
| in the past three months | | |
| Number of restaurants checked by consumer | 0-100 | 0.01 |
| 118 on the internet in past three months | | |
| Number of times consumer 118 has seen a | 0-100 | 0.04 |
| cookery show on TV in the past three months | | |

It should be appreciated that the factors (and their corresponding ranges) and the weightings included in Table 2 are provided for purposes of illustration, and are not intended to limit the scope of the present disclosure to the specific factors, score ranges, weights, or manner of generating the experience profile score. As such, experience profile scores may be generated in other ways, based on the same or other data (and/or other algorithms and/or other factors and/or other numbers of factors), as described above, or otherwise, and still be consistent with the description of the scope herein.

With that said, based on the data included in Tables 1 and 2 and the algorithm above, the profile engine 122 generates the experience profile score, for the consumer 118, on a scale of 0-100, as “84.35”, provided below. In so doing, the experience factors are utilized in the algorithm, in this example, based on the particular values of the factors on a scale of 0-100, with any values over 100 being capped at 100.

Experience Profile Score=((100×0.65)+(30×0.05)+(35×0.03)+(100×0.01)+(50×0.03)+(70×0.01)+(80×0.04)+(55×0.04)+(60×0.02)+(80×0.03)+(90×0.04)+(100×0.01)+(0×0.04))=84.35

Then, once the experience profile score is generated, the profile engine 122 distributes, at 324, the experience profile score for the consumer 118 to the review forum 110, whereupon the score may be appended to and/or displayed in connection with the review by the consumer 118. With that said, the profile engine 122 may, at one or more regular or irregular intervals or periodically (e.g., monthly, quarterly, etc.), etc. update the experience profile score for the consumer 118, as desired, to provide an updated experience profile score (e.g., for the review forum 110, etc.), or not. In general, the update includes repetition of operations of method 300 (e.g., at least operations 308-322 of method 300, etc.), where after the updated experience profile score is again distributed, at 324. In this manner, the experience profile score may be kept current and/or up to date and, as such, account for more recently compiled data from the payment network 106, the social network 112, and/or the media source 114, etc.

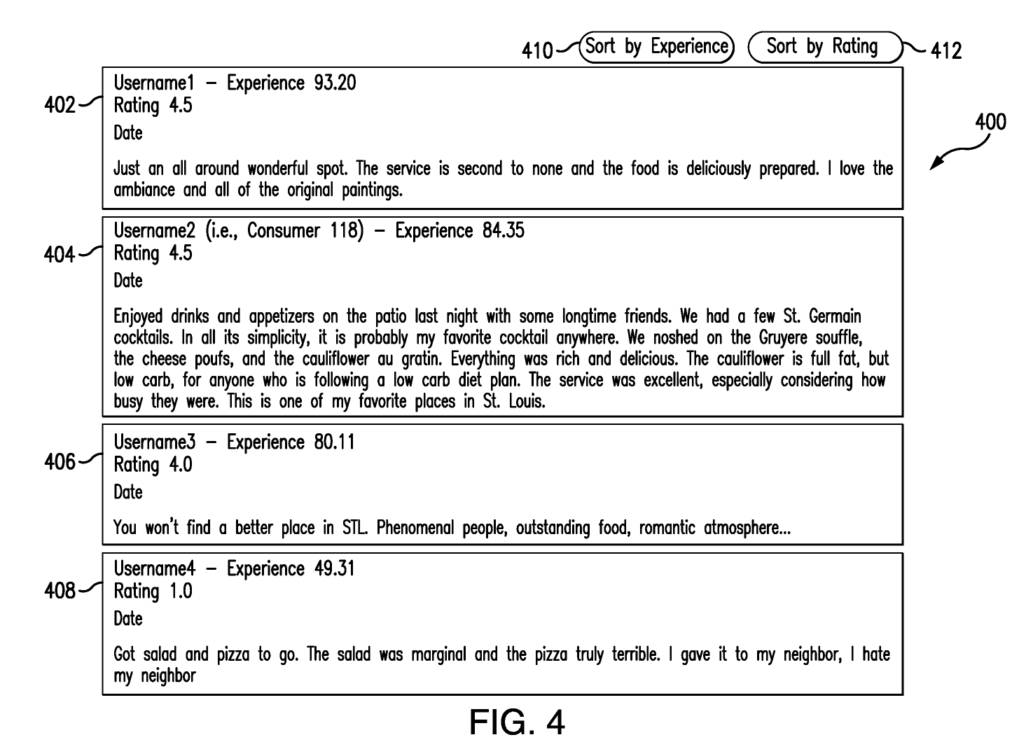

FIG. 4 includes an exemplary interface 400 associated with the review forum 110, which includes four different reviews 402-408 of the merchant 102. As shown, the review 404 from the consumer 118 is associated with the experience profile score of 84.35 for the consumer 118 (e.g., as generated above, etc.), and the other three reviews 402 and 406-408 are associated with different experience profile scores generated in a similar manner to the score for the consumer 118 (i.e., 93.20, 80.11, and 49.31, respectively). In addition, each of the reviews 402-408 includes a written remarks portion for the review as well as a rating (on a scale of 0-5). Of the three reviews 402 and 406-408 not including the consumer 118, the review 408 includes a lowest rating for the merchant 102 (i.e., a rating of 1.0) and negative remarks about the merchant 102 and the consumer's dining experience. The experience profile score for this review 408 is 49.31, however, indicating (to an individual/potential consumer reading the review) that the reviewer (i.e., Username4) is less experienced to provide the review on the particular subject matter (i.e., the merchant 102, and more generally, restaurants) than each of the other reviewers (i.e., Username1, Username2, and Username3) who are rated 93.2, 84.35 and 80.11, respectively. In this manner, the potential consumer may be able to put the generally negative review 408 into perspective and credit certain ones of the other reviews 402-406 over it, based on reviewer experience. In addition in the exemplary interface 400, the potential consumer has the option to sort the reviews, for example, by reviewer experience, via button 410, or to sort by rating, via button 412.

It should be understood that the exemplary interface 400 is provide for illustration purposes only, and should not be understood to limit the description herein to any particular interfaces and/or format of interfaces, as various other interfaces could be employed with the systems and methods herein.

In view of the above, the systems and methods herein may permit a potential consumer to better understand and credit (or discredit) a review based on the experience of the individual providing the review, as summarized, for example, by an experience profile score. Not only can this provide assistance to potential consumers reading the review, but the merchants (e.g., the merchant 102, etc.) that are the subject of the review may investigate and/or analyze the review to determine what they are doing right and what they are doing wrong. What's more, by relying more heavily, or exclusively, on reviews from experienced individuals, the potential consumers and/or merchants may be positioned to make better decisions regarding their purchases and/or their product offerings and service (e.g., appearance, employees, etc.).

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) receiving a request from a review forum for an experience profile score for a consumer, the request including a subject of a review associated with the consumer and a device identifier associated with the consumer and/or associated with a communication device of the consumer; (b) compiling data associated with the device identifier, the data including transaction data and at least one of social network content associated with the consumer and media content associated with the consumer; (c) generating the experience profile score for the consumer, in response to the request, based on the compiled data; and (d) distributing the experience profile score to the review forum for posting in connection with the review, whereby the experience profile score is associated with the review of the consumer and is related to the subject of the review.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” “associated with,” or “in communication with” another feature, element or layer, it may be directly on, engaged, connected, coupled, associated, or in communication with/to the other feature, element or layer, or intervening features, elements or layers may be present. In contrast, when feature, element or layer is referred to as being “directly on,” “directly engaged to,” “directly connected to,” “directly coupled to,” “directly associated with,” or “directly in communication with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the exemplary embodiments.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in providing experience profile scores for reviewers in connection with reviews submitted by the reviewers, the method comprising:
receiving, at a computing device, a request from a review forum for an experience profile score for a consumer, the request including a subject of a review associated with the consumer and a device identifier associated with the consumer and/or associated with a communication device of the consumer;
compiling data associated with the device identifier, the data including transaction data and at least one of social network content associated with the consumer and media content associated with the consumer;
generating, by the computing device, the experience profile score for the consumer, in response to the request, based on the compiled data; and
distributing the experience profile score to the review forum for posting in connection with the review, whereby the experience profile score is associated with the review of the consumer and is related to the subject of the review.

2. The computer-implemented method of claim 1, wherein the device identifier includes a payment token associated with the communication device.

3. The computer-implemented method of claim 2, wherein compiling the data associated with the device identifier includes retrieving transaction data for a payment account associated with the payment token for a defined interval.

4. The computer-implemented method of claim 1, wherein compiling the data associated with the device identifier includes:
identifying a social network associated with the consumer; and
retrieving social network content, from the social network, for the consumer based, at least in part, on the device identifier.

5. The computer-implemented method of claim 1, wherein generating the experience profile score is based on a number of factors indicated by the compiled data; and
wherein the number of factors includes a number of transactions at a subject merchant within a first interval and a number of transactions at merchants being in a same category as the subject merchant within a second interval, the subject merchant being included in the subject of the review.

6. The computer-implemented method of claim 5, wherein the number of factors further includes a number of social network posts related to the subject of the review and a frequency of media use related to the category of the subject merchant.

7. The computer-implemented method of claim 1, wherein the compiled data includes the transaction data, the social network content and the media content; and
wherein generating the experience profile score includes calculating a weighted sum of multiple factors, the multiple factors indicative of at least a portion of the compiled data.

8. The computer-implemented method of claim 7, wherein at least one of the multiple factors is associated with the subject merchant, the subject merchant being included in the subject of the review; and
wherein the at least one of the multiple factors associated with the subject merchant is weighted more heavily than any other one of the multiple factors.

9. The computer-implemented method of claim 1, wherein distributing the experience profile score includes transmitting the experience profile score to the review forum.

10. The computer-implemented method of claim 9, further comprising, after distributing the experience score to the review forum:
compiling further data associated with the device identifier, the further data including transaction data and at least one of social network content associated with the consumer and media content associated with the consumer; and
generating, by the computing device, an updated experience profile score for the consumer based on the further compiled data.

11. A system for use in providing experience profile scores for reviewers in connection with reviews submitted by the reviewers to a review forum, the system comprising a profile engine in communication with a memory, the profile engine configured to:
retrieve data for a consumer based on a device identifier for a communication device associated with the consumer, the communication device associated with a submission of a review of a merchant and/or a product to a review forum, the data including transaction data and at least one of social network content associated with the consumer and media content associated with the consumer;
store at least part of the retrieved data in the memory;
generate an experience profile score for the consumer based on the compiled data, the experience profile score indicative of an experience of the consumer with the merchant and/or the product associated with the review; and
transmit the experience profile score to the review forum for posting in connection with the review of the consumer, whereby the experience profile score is associated with the review of the consumer for consideration by other consumers accessing the review.

12. The system of claim 11, wherein the profile engine is configured, in connection with retrieving the transaction data, to retrieve the transaction data based on a merchant category code associated with said merchant.

13. The system of claim 12, wherein the profile engine is configured, in connection with retrieving the data for the consumer, to retrieve the transaction data for a first interval; and
wherein the profile engine is configured, in connection with retrieving the data for the consumer, to retrieve the social network content for a second interval, the first and second interval at least partially overlapping.

14. The system of claim 12, wherein the profile engine is configured to retrieve the data for the consumer in response to a request from the review forum for the experience profile score for the consumer.

15. The system of claim 11, wherein the profile engine is configured, in connection with generating the experience profile score for the consumer, to generate the experience profile score based on the following algorithm:
Experience Profile Score=(X₁*W₁)+(X₂*W₂)+(X₃*W₃)+ . . . (X_{Z}*W_{Z});
wherein X represents experience factors for the consumer as indicated by the retrieved data and W represents weightings associated with the corresponding experience factors.

16. The system of 15, wherein the data includes the transaction data, the social network content associated with the consumer, and the media content associated with the consumer; and
wherein the profile engine is configured, in connection with retrieving the data for the consumer, to retrieve the social network content from a social network associated with the consumer and to retrieve the media content from a media source associated with the consumer.

17. The system of claim 16, wherein the experience factors include two or more of: whether the consumer has performed a transaction at the merchant and/or purchased the product within an interval, a number of transactions by the consumer at the merchant and/or involving the product within the interval, a number of transactions by the consumer at merchants in a same category as said merchant and/or for products in a same category as said product within the interval, a total spend by the consumer at the merchant and/or for products corresponding to said product within the interval, a total spend by the consumer at merchants in a same category as said merchant and/or for products in a same category as said product within the interval, a number of pages relating to the merchant and/or the product liked/subscribed to by the consumer on the social network within the interval, and a number of videos relating to the merchant and/or the product viewed by the consumer via the media source within the interval.

18. A non-transitory computer-readable storage media including computer-executable instructions for use in providing experience profile scores for reviewers in connection with reviews submitted by the reviewers to a review forum, which, when executed by a processor, cause the processor to:
receive a request from a review forum for an experience profile score for a consumer, the request including a subject of a review associated with the consumer and a device identifier associated with a communication device of the consumer used to prepare and/or submit the review;
compile data associated with the device identifier, the data including transaction data associated with the consumer, social network content associated with the consumer, and media content associated with the consumer;
generate the experience profile score for the consumer, in response to the request, based on the compiled data, the experience profile score indicative of an experience of the consumer with a subject matter included in the review; and
transmit the experience profile score to the review forum for posting in connection with the review, whereby the experience profile score is associated with the review of the consumer and is related to the subject of the review.

19. The non-transitory computer-readable storage media of claim 18, wherein the executable instructions, when executed by the processor, cause the processor, in connection with generating the experience profile score for the consumer, to generate the experience profile score based on the following algorithm:
Experience Profile Score=(X₁*W₁)+(X₂*W₂)+(X₃*W₃)+ . . . (X_{Z}*W_{Z});
wherein X represents experience factors for the consumer as indicated by the compiled data and W represents weightings associated with the corresponding experience factors.

20. The non-transitory computer-readable storage media of claim 19, wherein the device identifier includes a payment token associated with the communication device; and
wherein the executable instructions, when executed by the processor, cause the processor, in connection with compiling the data associated with the device identifier, to retrieve the transaction data for a payment account associated with the payment token for a defined interval.

21. The non-transitory computer-readable storage media of claim 18, wherein the executable instructions, when executed by the processor, cause the processor, in connection with compiling the data associated with the device identifier, to retrieve the social network content from at least one social network, via an application programming interface (API) associated with the at least one social network; and
wherein the executable instructions, when executed by the processor, cause the processor, in connection with compiling the data associated with the device identifier, to retrieve the media content from at least one media source, via an API associated with the at least one media source.
